(19) United States
(12) Patent Application Publication
(10) Pub. No.: US 2026/0245224 A1
(43) Pub. Date: Aug. 20, 2026

(54) THREE-DIMENSIONAL SPACE ESTIMATION SYSTEM

(71) Applicant: NTT DOCOMO, INC., Tokyo (JP)

(72) Inventors: Koyo KOBAYASHI, Tokyo (JP); Mirai HARA, Tokyo (JP); Rina SATOU, Tokyo (JP)

(73) Assignee: NTT DOCOMO, INC., Tokyo (JP)

(21) Appl. No.: 19/162,219

(22) PCT Filed: May 15, 2024
(86) PCT No.: PCT/JP2024/017978

§ 371 Date: Sep. 4, 2025

(30) Foreign Application Priority Data
May 22, 2023 (JP) 2023-083970

(51) Int. Cl. G06T 7/50; G06T 7/13; G06T 7/73; G06T 17/00

(52) U.S. Cl. CPC G06T 7/50; G06T 7/13; G06T 7/75; G06T 17/00; G06T 2207/30168

(57) ABSTRACT

A three-dimensional space estimation system includes a relative depth acquisition unit that acquires relative depth information of a two-dimensional image, a reference line setting unit that sets a detected straight line as a reference line, a reference point setting unit that sets multiple reference points on the reference line and assigns three-dimensional coordinates to each using a first coefficient to convert relative depth to absolute depth, a two-dimensional coordinate acquisition unit that acquires two-dimensional coordinates of each reference point, a parameter calculation unit that calculates parameters of a conversion formula and the first coefficient by substituting the three-dimensional and two-dimensional coordinates of the reference point into a formula representing a their relationship, and a three-dimensional space model generation unit that generates a three-dimensional space model by arranging each pixel of the two-dimensional image in a three-dimensional space using the parameters, the first coefficient, and each pixel's relative depth.

### TECHNICAL FIELD

The present invention relates to a three-dimensional space estimation system.

### BACKGROUND ART

There is a demand for a technique of estimating a three-dimensional space on the basis of a two-dimensional image (monocular image). For example, Patent Literature 1 discloses a technique of using a target image including one or more reference markers whose images are captured by an imaging device to formulate a correspondence between image coordinates and global coordinates and to determine calibration parameters of the imaging device. A three-dimensional space based on a two-dimensional image can be estimated on the basis of the correspondence relation between the image coordinates and the global coordinates.

### CITATION LIST

### Patent Literature

[Patent Literature 1] Japanese Unexamined Patent Publication No. 2017-513079

### SUMMARY OF INVENTION

### Technical Problem

As described above, in order to estimate a three-dimensional space from a two-dimensional image, it is necessary to obtain various parameters related to the projection of the three-dimensional space onto the two-dimensional image and the correspondence relation between coordinates in the two-dimensional image and coordinates in the three-dimensional space. However, it has been necessary to install markers or the like in advance whose coordinates in the three-dimensional space are known, and installing such markers in advance in the target three-dimensional space has required considerable time and effort. In addition, it has been impossible to obtain various parameters and the correspondence relation between the coordinates of a two-dimensional image and the coordinates of a three-dimensional space from past images or the like in which no markers are installed.

Consequently, the present invention was contrived in view of the above problem, and an object thereof is to estimate a three-dimensional space from a two-dimensional image without using any installed objects such as markers.

### Solution to Problem

In order to solve the above problem, according to an aspect of the present disclosure, there is provided a three-dimensional space estimation system configured to estimate a three-dimensional space represented in a two-dimensional image, the system including: a relative depth acquisition unit configured to acquire relative depth information indicating a relative depth of each pixel of the two-dimensional image which is an image obtained by projecting the three-dimensional space; a reference line setting unit configured to detect one or more straight lines from the two-dimensional image and set the detected straight lines as reference lines; a reference point setting unit configured to set a plurality of points per reference line as reference points on the reference line and set three-dimensional coordinates of each reference point in the three-dimensional space by using a first coefficient for converting the relative depth into an absolute depth in common for at least each reference point; a two-dimensional coordinate acquisition unit configured to acquire two-dimensional coordinates of each reference point in the two-dimensional image; a parameter calculation unit configured to calculate parameters of the conversion formula and the first coefficient by substituting the three-dimensional coordinates and the two-dimensional coordinates of the reference point into a predetermined conversion formula that expresses a relationship between three-dimensional coordinates in the three-dimensional space and two-dimensional coordinates in the two-dimensional image using predetermined parameters; and a three-dimensional space model generation unit configured to generate a three-dimensional space model representing the three-dimensional space by arranging pixel values of each pixel of the two-dimensional image at corresponding positions in the three-dimensional space using at least a portion of the parameters calculated by the parameter calculation unit, the first coefficient, and the relative depth of each pixel.

According to the above aspect, relative depth information of a two-dimensional image is acquired. In addition, a straight line detected from the two-dimensional image is set as a reference line, and a plurality of reference points are set on the reference line. Since the reference points are linearly arranged on the straight line, the three-dimensional coordinates of each reference point can be set using the first coefficient in common. The parameters of the conversion formula and the first coefficient are then calculated by applying the two-dimensional coordinates and three-dimensional coordinates of the reference point to the conversion formula. Therefore, the pixel values of each pixel can be arranged at corresponding positions in the three-dimensional space on the basis of the conversion formula to which the calculated parameters are applied, the first coefficient, and the relative depth of each pixel, which makes it possible to estimate the three-dimensional space.

### Advantageous Effects of Invention

It is possible to estimate a three-dimensional space from a two-dimensional image without using any installed objects such as markers.

### BRIEF DESCRIPTION OF DRAWINGS

FIG. 1 is a block diagram illustrating a functional configuration of a three-dimensional space estimation system and a three-dimensional space estimation device according to the present embodiment.

FIG. 2 is a diagram illustrating an example of a two-dimensional image to be processed.

FIG. 3 is a diagram illustrating an example of a relative depth map corresponding to a two-dimensional image.

FIG. 4 is a diagram illustrating an example of a process of setting a reference line in a two-dimensional image.

FIG. 5 is a diagram illustrating an example of setting reference points.

FIG. 6 is a diagram illustrating a first coefficient and a second coefficient.

FIG. 7 is a diagram illustrating an example of an estimated three-dimensional space model.

FIG. 8 is a flowchart illustrating processing content of a three-dimensional space estimation method in a three-dimensional space estimation device.

FIG. 9 is a diagram illustrating a configuration of a three-dimensional space estimation program.

FIG. 10 is a hardware block diagram of the three-dimensional space estimation device.

### DESCRIPTION OF EMBODIMENTS

An embodiment of a three-dimensional space estimation system according to the present invention will be described with reference to the accompanying drawings. Meanwhile, the same components are denoted, if possible, by the same reference numerals and signs, and thus description thereof will not be repeated.

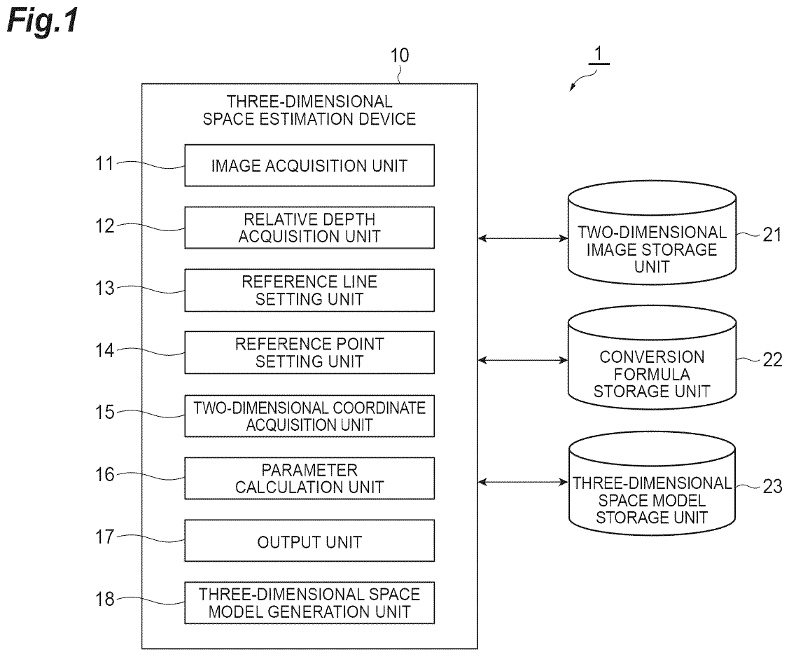

FIG. 1 is a diagram illustrating a functional configuration of a three-dimensional space estimation system and a three-dimensional space estimation device according to the present embodiment. A three-dimensional space estimation system 1 of the present embodiment is a system that estimates a three-dimensional space represented in a two-dimensional image, and is configured, as an example, by a three-dimensional space estimation device 10. The two-dimensional image is, for example, a monocular camera image.

As shown in FIG. 1, the three-dimensional space estimation device 10 functionally includes an image acquisition unit 11, a relative depth acquisition unit 12, a reference line setting unit 13, a reference point setting unit 14, a two-dimensional coordinate acquisition unit 15, a parameter calculation unit 16, an output unit 17, and a three-dimensional space model generation unit 18. Each of these functional units 11 to 18 may be configured in one device as illustrated in FIG. 1, or may be configured to be distributed among a plurality of devices.

Each of the functional units 11 to 18 of the three-dimensional space estimation device 10 is configured to be accessible to storage means (storage) such as a two-dimensional image storage unit 21, a conversion formula storage unit 22, and a three-dimensional space model storage unit 23. Each of the storage units 21 to 23 may be included in the three-dimensional space estimation device 10, or may be configured in another device which is configured to be accessible from the three-dimensional space estimation device 10 as illustrated in FIG. 1.

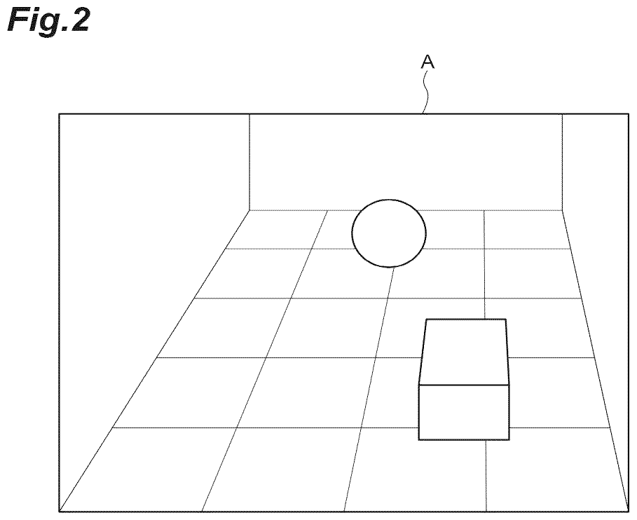

Next, each functional unit of the three-dimensional space estimation device 10 will be described. The image acquisition unit 11 acquires a two-dimensional image obtained by projecting a three-dimensional space. FIG. 2 is a diagram illustrating an example of a two-dimensional image A acquired by the image acquisition unit. The two-dimensional image A is, for example, an image of a three-dimensional space captured by a monocular camera. The two-dimensional image A may be an image extracted from a moving image obtained by capturing a three-dimensional space.

The image acquisition unit 11 may acquire the two-dimensional image A from a camera. In addition, the image acquisition unit 11 may acquire the two-dimensional image A from the two-dimensional image storage unit 21. The two-dimensional image storage unit 21 is a storage means for storing two-dimensional images in advance.

The relative depth acquisition unit 12 acquires relative depth information indicating the relative depth of each pixel of the two-dimensional image. The relative depth acquisition unit 12 may acquire a relative depth map corresponding to the two-dimensional image as the relative depth information. The relative depth map is information indicating relative depth information for each pixel using numerical values.

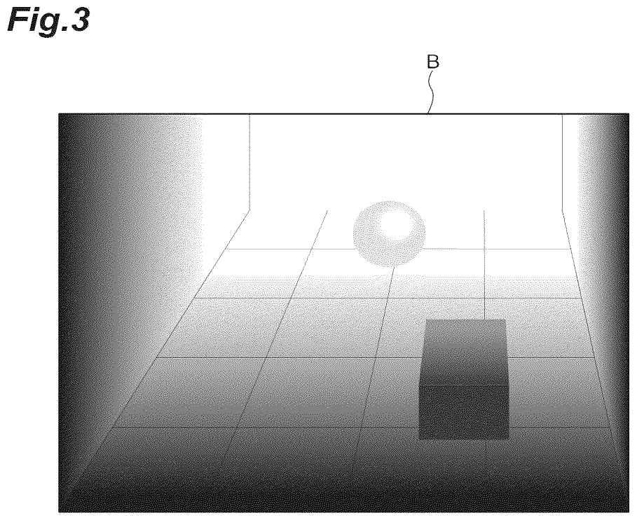

FIG. 3 is a diagram illustrating an example of a relative depth map corresponding to the two-dimensional image shown in FIG. 2. In a relative depth map B illustrated in FIG. 3, the relative depth value becomes smaller (closer to black) as the distance of an object represented by each pixel from the camera decreases, and the relative depth value becomes larger (closer to white) as the distance thereof from the camera increases. Since the relative depth values are relative values, each pixel cannot be projected into the 3D space at the same scale as the actual object. Meanwhile, there is no upper limit to the value of each pixel, but it is possible to produce a representation such as a black and white photograph as illustrated in FIG. 3.

The relative depth information can be acquired by, for example, a well-known machine learning-based technique such as MiDaS, and there is no limitation on methods by which the relative depth acquisition unit 12 acquires the relative depth information. The relative depth acquisition unit 12 may acquire the relative depth map B corresponding to the two-dimensional image A which is generated in advance and stored in the two-dimensional image storage unit 21.

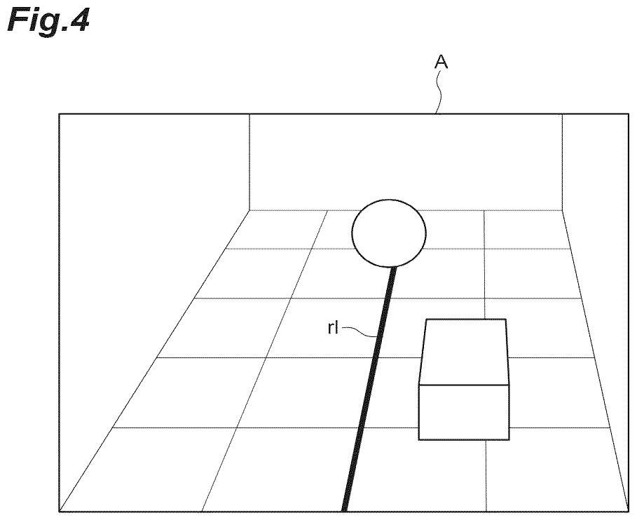

The reference line setting unit 13 detects one or more straight lines from the two-dimensional image and sets the detected straight lines as reference lines. FIG. 4 is a diagram illustrating an example of a process of setting reference lines in a two-dimensional image. As shown in FIG. 4, the reference line setting unit 13 detects straight lines from the two-dimensional image.

The reference line setting unit 13 may detect straight lines from the two-dimensional image A through a Hough transform. There is no limitation on methods by which the reference line setting unit 13 detects straight lines from the two-dimensional image, and, for example, a well-known technique of detecting edges from an image may be applied.

The reference line setting unit 13 sets a straight line detected from the two-dimensional image A as a reference line rl. The reference line setting unit 13 may detect a plurality of straight lines from the two-dimensional image A. The reference line setting unit 13 may then set a plurality of straight lines out of the plurality of straight lines detected from the two-dimensional image A as the reference line rl. Setting a plurality of reference line makes it possible to improve the accuracy in the calculation of parameters of a conversion formula to be described later.

In addition, the reference line setting unit 13 may set, as the reference line rl, one or more straight lines having the highest ranks in length among the plurality of straight lines detected from the two-dimensional image A. Setting a longer straight line as the reference line rl makes it possible to improve the accuracy in the calculation of parameters of a conversion formula to be described later.

The reference point setting unit 14 sets a plurality of points per reference line as reference points on the reference line rl. The reference point setting unit 14 then sets the three-dimensional coordinates of each reference point in the three-dimensional space by using a first coefficient for converting a relative depth into an absolute depth in common at least for each reference point.

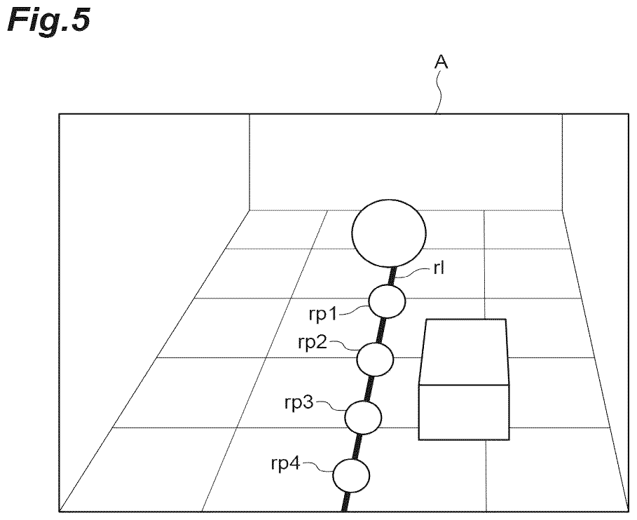

FIG. 5 is a diagram illustrating an example of setting reference points. As shown in FIG. 5, the reference point setting unit 14 sets a plurality of reference points rp1 to rp4 (rp) on the reference line rl set by the reference line setting unit 13. The number of reference points rp to be set is not limited insofar as it is plural, but a minimum number may be specified due to constraints resulting from a conversion formula to be described later.

The reference point setting unit 14 may set a plurality of reference points rp at equal intervals. Setting the reference points rp at equal intervals simplifies the ratio of the distances between the three-dimensional coordinates set for each reference point, which makes it easier to calculate the parameters and coefficients of a conversion formula to be described later.

The reference point setting unit 14 may set a first coordinate axis out of first to third coordinate axes in the three-dimensional space so as to be along the reference line rl, and set the three-dimensional coordinates of each reference point rp in the three-dimensional space by using the first coefficient and a second coefficient for converting the absolute depth into a distance along the first coordinate axis in common for each reference point.

Specifically, the reference point setting unit 14 sets a coordinate system constituted by an X axis, a Y axis, and a Z axis so that the Z axis is along the reference line. The reference point setting unit 14 may set the three-dimensional coordinates of the reference points rp1 to rp4, which are set at equal intervals, for example, as follows, with the first coefficient for converting the relative depth into an absolute depth as a and the second coefficient for converting the absolute depth into a distance along the Z axis as β.

$$rp 1 ( 0 , 0 , 1 \times α \times β )$$

$$rp 2 ( 0 , 0 , 2 \times α \times β )$$

$$rp 3 ( 0 , 0 , 3 \times α \times β )$$

$$rp 4 ( 0 , 0 , 4 \times α \times β )$$

That is, since the Z axis is set to be along the reference line rl, the X coordinates and Y coordinates of each reference point rp can be set to 0.

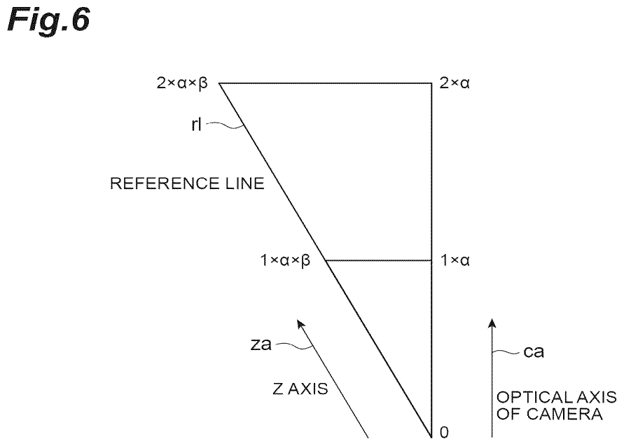

FIG. 6 is a diagram illustrating the first coefficient and the second coefficient. As shown in FIG. 6, the absolute depths 1×α and 2×α along the optical axis ca of the camera expressed using the first coefficient α are converted into 1×α×β and 2×α×β, respectively, using the second coefficient β in a coordinate system in which the reference line rl serves as the Z axis za. Therefore, the second coefficient β varies depending on the angle of the reference line rl with respect to the optical axis ca of the camera.

In this way, by setting a coordinate system in which the Z axis is aligned with the reference line and setting the three-dimensional coordinates of each reference point using the first coefficient α and the second coefficient β in common, the reference line rl can be set regardless of the angle of the camera of the two-dimensional image with respect to the optical axis. Meanwhile, in a case where the Z axis is along the optical axis of the camera, the relation of β=1 is established, and thus the three-dimensional coordinates of the reference point rp may be set without using the second coefficient β.

The two-dimensional coordinate acquisition unit 15 acquires the two-dimensional coordinates of each reference point rp in the two-dimensional image. Specifically, the two-dimensional coordinate acquisition unit 15 acquires the coordinates of the reference points rp1 to rp4 in the coordinate system set in the two-dimensional image A. The coordinates of the reference points rp1 to rp4 are expressed, for example, as follows.

$$rp 1 ( u 1 , v 1 )$$

$$rp 2 ( u 2 , v 2 )$$

$$rp 3 ( u 3 , v 3 )$$

$$rp 4 ( u 4 , v 4 )$$

The parameter calculation unit 16 calculates the parameters of the conversion formula and the coefficients included in the three-dimensional coordinates by substituting the three-dimensional coordinates and the two-dimensional coordinates set for the reference point rp into a predetermined conversion formula. The predetermined conversion formula is a formula that expresses the relationship between the three-dimensional coordinates in the three-dimensional space and the two-dimensional coordinates in the two-dimensional image using predetermined parameters.

The parameter calculation unit 16 calculates at least the first coefficient α included in the three-dimensional coordinates of the reference point rp. In addition, in a case where the first coefficient α and the second coefficient β are included in the three-dimensional coordinates of the reference point rp, the parameter calculation unit 16 calculates the second coefficient β in addition to the first coefficient α.

The parameters of the conversion formula may include six camera external parameters, four camera internal parameters, and five parameters related to the lens distortion of the camera, which are related to projection of the three-dimensional space onto the two-dimensional image.

In a case where the first coefficient α and the second coefficient β are included in the three-dimensional coordinates of the reference point rp, the parameter calculation unit 16 calculates a total of seventeen variables, inclusive of the fifteen parameters of the conversion formula and the first and second coefficients.

In calculating the parameters and the like of the conversion formula using the three-dimensional coordinates and two-dimensional coordinates of the reference point rp, parameters that change with respect to the coordinate system determined by the setting of the reference line rl are six camera external parameters and the second coefficient β. Therefore, since six variables need to be calculated for one reference line and two variables can be calculated for each reference point, the reference point setting unit 14 sets at least four reference points rp for one reference line rl. In this way, by setting an appropriate number of reference points according to the number of parameters constituting the conversion formula, it becomes possible to reliably calculate those parameters.

The parameter calculation unit 16 may calculate camera external parameters R (three degrees of freedom) and t (three degrees of freedom), camera internal parameters fₓ, f_{y}, cₓ, and c_{y}, and camera lens distortion-related parameters k₁, k₂, k₃, p₁, and p₂, as well as the first coefficient and the second coefficient, in the following conversion formula representing the relationship between the three-dimensional coordinates (X, Y, Z) in the three-dimensional space and the two-dimensional coordinates (u, v) in the two-dimensional image.

$$[ \begin{matrix}x \\ y \\ z\end{matrix} ] = R [ \begin{matrix}X \\ Y \\ Z\end{matrix} ] + t \qquad [ Expression 1 ]$$

$${x}^{′} = x / z$$

$${y}^{′} = y / z$$

$${x}^{″} = {x}^{′} ( 1 + {k}_{1} {r}^{2} + {k}_{2} {r}^{4} + {k}_{3} {r}^{6} ) + 2 {p}_{1} {x}^{′} {y}^{′} + {p}_{2} ( {r}^{2} + 2 {x}^{′2} )$$

$${y}^{″} = {y}^{′} ( 1 + {k}_{1} {r}^{2} + {k}_{2} {r}^{4} + {k}_{3} {r}^{6} ) + {p}_{1} ( {r}^{2} + 2 {y}^{′2} ) + 2 {p}_{2} {x}^{′} {y}^{′}$$

$$where {r}^{2} = {x}^{′2} + {y}^{′2}$$

$$u = {f}_{x} * {x}^{″} + {c}_{x}$$

$$v = {f}_{y} * {y}^{″} + {c}_{y}$$

The above defined conversion formula makes it possible to appropriately express the correspondence relation between the three-dimensional space and the two-dimensional image. By calculating the parameters of the conversion formula and the first and second coefficients, it becomes possible to correct the distortion of the two-dimensional image A and to acquire the absolute depth of each pixel of the two-dimensional image A.

The absolute depth of each pixel of two-dimensional image can be acquired on the basis of the relative depth of the pixel (acquired from the relative depth map) and the first coefficient α. This makes it possible to project each pixel of the two-dimensional image A to a position indicated by the absolute depth.

Meanwhile, the above conversion formula is merely an example and is not limited. For example, the above conversion formula can be simplified by ignoring the lens distortion of the camera and setting the parameters k₁, k₂, k₃, p₁, and p₂ to 0.

Referring back to FIG. 1, the output unit 17 may output the conversion formula. Specifically, the output unit 17 may cause the conversion formula storage unit 22 to store the parameters calculated by the parameter calculation unit 16. In addition, the output unit 17 may cause at least the conversion formula storage unit 22 to store the calculated first coefficient. In addition, the output unit 17 may cause the conversion formula storage unit 22 to further store the second coefficient. The conversion formula storage unit 22 is a storage means capable of storing a conversion formula defined by the parameters calculated by the parameter calculation unit 16, the and first and second coefficients, and the like.

The three-dimensional space model generation unit 18 generates a three-dimensional space model representing the three-dimensional space by arranging the pixel values of each pixel of the two-dimensional image A at corresponding positions in the three-dimensional space.

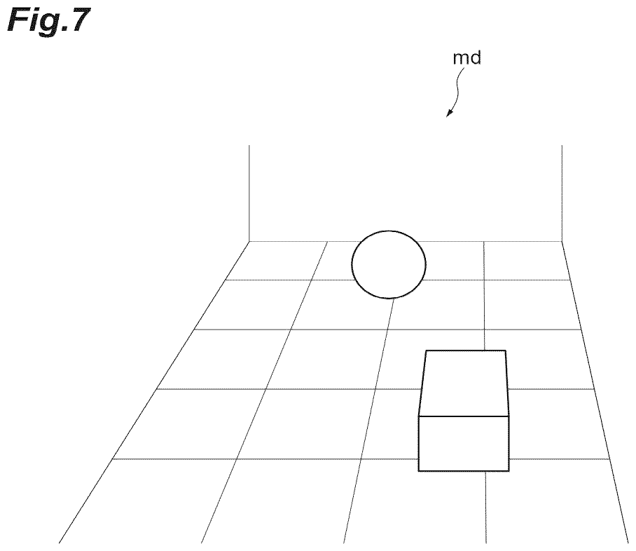

FIG. 7 is a diagram illustrating an example of a three-dimensional space model. Specifically, the three-dimensional space model generation unit 18 corrects the two-dimensional image A using various parameters calculated by the parameter calculation unit 16. Specifically, the three-dimensional space model generation unit 18 may correct the distortion of the two-dimensional image A using a well-known method based on the camera lens distortion-related parameters k₁, k₂, k₃, p₁, and p₂.

In addition, the three-dimensional space model generation unit 18 may acquire the absolute depth of each pixel of the two-dimensional image A on the basis of the relative depth map B and at least first coefficient α. Specifically, the three-dimensional space model generation unit 18 acquires the relative depth of each pixel of the two-dimensional image A from the relative depth map B, and acquires the absolute depth by applying the first coefficient α to the relative depth. The three-dimensional space model generation unit 18 may acquire the absolute depth of each pixel of the two-dimensional image A by further applying the second coefficient β to the relative depth. The three-dimensional space model generation unit 18 generates a three-dimensional space model md representing a three-dimensional space corresponding to the two-dimensional image A by projecting each pixel of the two-dimensional image A to a position represented by the absolute depth and arranging the pixel values of each pixel in the three-dimensional space.

The three-dimensional space model generation unit 18 may cause the three-dimensional space model storage unit 23 to store data representing the generated three-dimensional space model md. The three-dimensional space model storage unit 23 is a storage means for storing the generated three-dimensional space model md.

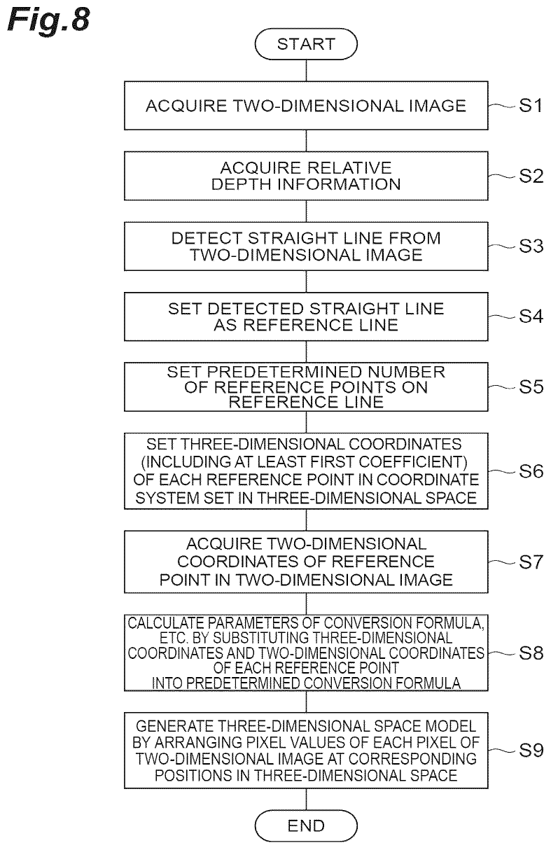

FIG. 8 is a flowchart illustrating processing content of a three-dimensional space estimation method in the three-dimensional space estimation system 1.

In step S1, the image acquisition unit 11 acquires the two-dimensional image A obtained by projecting a three-dimensional space. In step S2, the relative depth acquisition unit 12 acquires relative depth information (for example, the relative depth map B) indicating the relative depth of each pixel of the two-dimensional image A.

In step S3, the reference line setting unit 13 detects one or more straight lines from the two-dimensional image A. In step S4, the reference line setting unit 13 sets the detected straight lines as the reference line rl.

In step S5, the reference point setting unit 14 sets a predetermined number of plural reference points rp on the reference line rl. In step S6, the reference point setting unit 14 sets the three-dimensional coordinates of each reference point rp in the coordinate system set in the three-dimensional space. The three-dimensional coordinates set for each reference point rp are set using the first coefficient α for converting the relative depth into an absolute depth in common at least for each reference point.

In step S7, the two-dimensional coordinate acquisition unit 15 acquires the two-dimensional coordinates of each reference point rp in the two-dimensional image. Specifically, the two-dimensional coordinate acquisition unit 15 acquires the coordinates of the reference point rp in the coordinate system set in the two-dimensional image A.

In step S8, the parameter calculation unit 16 calculates the parameters of the conversion formula and the coefficients included in the three-dimensional coordinates by substituting the three-dimensional coordinates and the two-dimensional coordinates set for the reference point rp into a predetermined conversion formula. The predetermined conversion formula is a formula that expresses the relationship between the three-dimensional coordinates in the three-dimensional space and the two-dimensional coordinates in the two-dimensional image using predetermined parameters.

In step S9, the three-dimensional space model generation unit 18 generates a three-dimensional space model representing the three-dimensional space by arranging the pixel values of each pixel of the two-dimensional image A at corresponding positions in the three-dimensional space. Specifically, the three-dimensional space model generation unit 18 corrects the two-dimensional image A using various parameters calculated by the parameter calculation unit 16. The three-dimensional space model generation unit 18 then arranges the pixel values of each pixel in the three-dimensional space by projecting each pixel of the two-dimensional image A to a position represented by the absolute depth acquired on the basis of the first coefficient and the relative depth information.

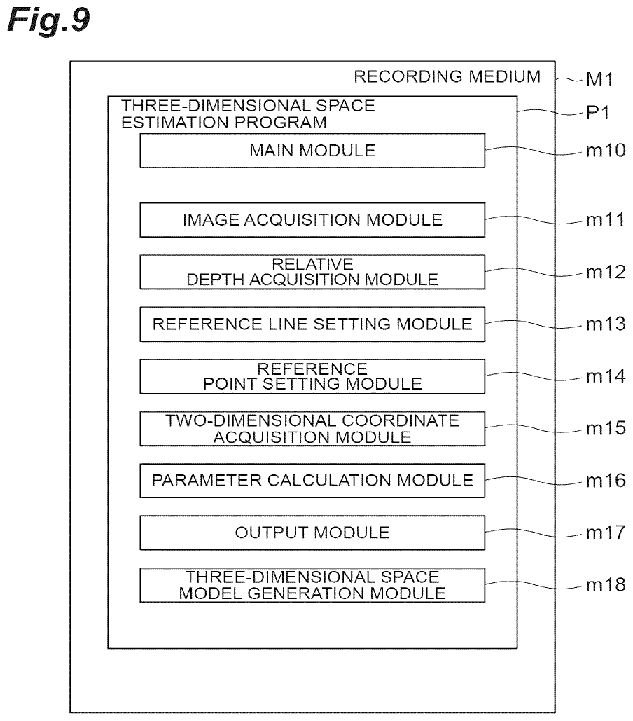

Next, a three-dimensional space estimation program for causing a computer to function as the three-dimensional space estimation device 10 of the present embodiment will be described with reference to FIG. 9. FIG. 9 is a diagram illustrating a configuration of a three-dimensional space estimation program. A three-dimensional space estimation program P1 is configured to include a main module m10 that comprehensively controls a three-dimensional space estimation process in the three-dimensional space estimation device 10, an image acquisition module m11, a relative depth acquisition module m12, a reference line setting module m13, a reference point setting module m14, a two-dimensional coordinate acquisition module m15, a parameter calculation module m16, an output module m17, and a three-dimensional space model generation module m18. Each of the modules m11 to m18 realizes a function for each of the functional units 11 to 18.

Meanwhile, the three-dimensional space estimation program P1 may be transmitted through a transmission medium such as a communication line, or may be stored in a recording medium M1 as shown in FIG. 9.

According to the three-dimensional space estimation system, the three-dimensional space estimation device 10, the three-dimensional space estimation method, and the three-dimensional space estimation program P1 of the present embodiment described above, relative depth information B of the two-dimensional image A is acquired. In addition, a straight line detected from the two-dimensional image A is set as the reference line rl, and a plurality of reference points rp are set on the reference line rl. Since the reference points rp are linearly arranged on a straight line, the three-dimensional coordinates of each reference point rp can be set using the first coefficient α in common. The parameters of the conversion formula and the first coefficient α are then calculated by applying the two-dimensional coordinates and three-dimensional coordinates of the reference point rp to the conversion formula. Therefore, the pixel values of each pixel can be arranged at corresponding positions in the three-dimensional space on the basis of the calculated parameters, first coefficient α, and the relative depth of each pixel, which makes it possible to estimate the three-dimensional space.

The three-dimensional space estimation system according to the present disclosure may have the following configurations. In addition, the operations and effects of each configuration will be described as follows.

According to an aspect of the present disclosure, there is provided a three-dimensional space estimation system configured to estimate a three-dimensional space represented in a two-dimensional image, the system including: a relative depth acquisition unit configured to acquire relative depth information indicating a relative depth of each pixel of the two-dimensional image which is an image obtained by projecting the three-dimensional space; a reference line setting unit configured to detect one or more straight lines from the two-dimensional image and set the detected straight lines as reference lines; a reference point setting unit configured to set a plurality of points per reference line as reference points on the reference line and set three-dimensional coordinates of each reference point in the three-dimensional space by using a first coefficient for converting the relative depth into an absolute depth in common for at least each reference point; a two-dimensional coordinate acquisition unit configured to acquire two-dimensional coordinates of each reference point in the two-dimensional image; a parameter calculation unit configured to calculate parameters of the conversion formula and the first coefficient by substituting the three-dimensional coordinates and the two-dimensional coordinates of the reference point into a predetermined conversion formula that expresses a relationship between three-dimensional coordinates in the three-dimensional space and two-dimensional coordinates in the two-dimensional image using predetermined parameters; and a three-dimensional space model generation unit configured to generate a three-dimensional space model representing the three-dimensional space by arranging pixel values of each pixel of the two-dimensional image at corresponding positions in the three-dimensional space using at least a portion of the parameters calculated by the parameter calculation unit, the first coefficient, and the relative depth of each pixel.

According to the above aspect, relative depth information of a two-dimensional image is acquired. In addition, a straight line detected from the two-dimensional image is set as a reference line, and a plurality of reference points are set on the reference line. Since the reference points are linearly arranged on the straight line, the three-dimensional coordinates of each reference point can be set using the first coefficient in common. The parameters of the conversion formula and the first coefficient are then calculated by applying the two-dimensional coordinates and three-dimensional coordinates of the reference point to the conversion formula. Therefore, the pixel values of each pixel can be arranged at corresponding positions in the three-dimensional space on the basis of the calculated parameter, the first coefficient, and the relative depth of each pixel, which makes it possible to estimate the three-dimensional space.

In addition, in the three-dimensional space estimation system according to another aspect, the reference point setting unit may set the plurality of reference points at equal intervals.

According to the above aspect, the ratio of the distances between the three-dimensional coordinates of each reference point is simplified, which makes it easier to calculate the parameters of the conversion formula and the first coefficient.

In addition, in the three-dimensional space estimation system according to another aspect, the reference point setting unit may set a first coordinate axis out of first to third coordinate axes in the three-dimensional space so as to be along the reference line, and set the three-dimensional coordinates in the three-dimensional space of each reference point by using the first coefficient and a second coefficient for converting the absolute depth into a distance along the first coordinate axis in common for each reference point.

According to the above aspect, by setting a coordinate system in which the first coordinate axis is aligned with the reference line and setting the three-dimensional coordinates of each reference point using the first coefficient and the second coefficient in common, the reference line can be set regardless of the angle with respect to the optical axis.

In addition, in the three-dimensional space estimation system according to another aspect, the parameters of the conversion formula may include predetermined six camera external parameters, four camera internal parameters, and five parameters related to lens distortion of the camera, which are related to projection of the three-dimensional space onto the two-dimensional image, and the reference point setting unit may set at least four reference points for one reference line.

According to the above aspect, an appropriate number of reference points are set according to the number of parameters constituting the conversion formula, so that the parameters are reliably calculated. It becomes possible to appropriately express the correspondence relation between the three-dimensional space and the two-dimensional image using the conversion formula.

In addition, in the three-dimensional space estimation system according to another aspect, the parameter calculation unit may calculate camera external parameters R and t, each having three degrees of freedom, camera internal parameters fₓ, f_{y}, cₓ, and c_{y}, and camera lens distortion-related parameters k₁, k₂, k₃, p₁, and p₂, as well as the first coefficient and the second coefficient, in the following conversion formula representing a relationship between three-dimensional coordinates (X, Y, Z) in a three-dimensional space and two-dimensional coordinates (u, v) in a two-dimensional image.

$$[ \begin{matrix}x \\ y \\ z\end{matrix} ] = R [ \begin{matrix}X \\ Y \\ Z\end{matrix} ] + t \qquad [ Expression 2 ]$$

$${x}^{′} = x / z$$

$${y}^{′} = y / z$$

$${x}^{″} = {x}^{′} ( 1 + {k}_{1} {r}^{2} + {k}_{2} {r}^{4} + {k}_{3} {r}^{6} ) + 2 {p}_{1} {x}^{′} {y}^{′} + {p}_{2} ( {r}^{2} + 2 {x}^{′2} )$$

$${y}^{″} = {y}^{′} ( 1 + {k}_{1} {r}^{2} + {k}_{2} {r}^{4} + {k}_{3} {r}^{6} ) + {p}_{1} ( {r}^{2} + 2 {y}^{′2} ) + 2 {p}_{2} {x}^{′} {y}^{′}$$

$$where {r}^{2} = {x}^{′2} + {y}^{′2}$$

$$u = {f}_{x} * {x}^{″} + {c}_{x}$$

$$v = {f}_{y} * {y}^{″} + {c}_{y}$$

According to the above aspect, the defined conversion formula makes it possible to appropriately express the correspondence relation between the three-dimensional space and the two-dimensional image using the conversion formula.

In addition, in the three-dimensional space estimation system according to another aspect, the reference line setting unit may set, as the reference line, one or more straight lines having the highest ranks in length among the one or more detected straight lines.

According to the above aspect, a longer straight line out of the straight lines detected from the two-dimensional image is set as the reference line, which makes it possible to improve the accuracy of the calculated parameters.

In addition, in the three-dimensional space estimation system according to another aspect, the reference line setting unit may set a plurality of straight lines out of the one or more detected straight lines as the reference lines.

According to the above aspect, a plurality of straight lines out of the straight lines detected from the two-dimensional image are set as the reference lines, which makes it possible to improve the accuracy of the calculated parameters.

Meanwhile, the block diagram shown in FIG. 1 represents blocks in units of functions. These functional blocks (constituent elements) are realized by any combination of at least one of hardware and software. In addition, a method of realizing each functional block is not particularly limited. That is, each functional block may be realized using one device which is physically or logically coupled, or may be realized using two or more devices which are physically or logically separated from each other by connecting the plurality of devices directly or indirectly (for example, using a wired or wireless manner or the like). The functional block may be realized by combining software with the one device or the plurality of devices.

Examples of the functions include determining, deciding, judging, calculating, computing, processing, deriving, investigating, searching, ascertaining, receiving, transmitting, outputting, accessing, resolving, selecting, choosing, establishing, comparing, assuming, expecting, considering, broadcasting, notifying, communicating, forwarding, configuring, reconfiguring, allocating (or mapping), assigning, and the like, but there is no limitation thereto. For example, a functional block (constituent element) for allowing a transmitting function is referred to as a transmitting unit or a transmitter. In either case, as described above, realization methods are not particularly limited.

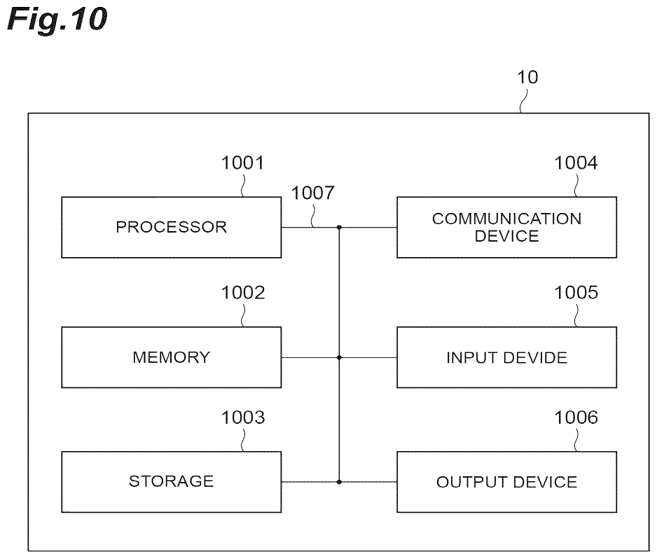

For example, the three-dimensional space estimation device 10 in an embodiment of the present invention may function as a computer. FIG. 10 is a diagram illustrating an example of a hardware configuration of the three-dimensional space estimation device 10 according to the present embodiment. The three-dimensional space estimation device 10 may be physically configured as a computer device including a processor 1001, a memory 1002, a storage 1003, a communication device 1004, an input device 1005, an output device 1006, a bus 1007, and the like.

Meanwhile, in the following description, the word “device” may be replaced with “circuit,” “unit,” or the like. The hardware configuration of the three-dimensional space estimation device 10 may be configured to include one or a plurality of devices shown in the drawings, or may be configured without including some of the devices.

The processor 1001 performs an arithmetic operation by reading predetermined software (a program) on hardware such as the processor 1001 or the memory 1002, and thus each function in the three-dimensional space estimation device 10 is realized by controlling communication in the communication device 1004 and reading and/or writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like. For example, each of the functional units 11 to 18 and the like shown in FIG. 1 may be realized by the processor 1001.

In addition, the processor 1001 reads out a program (program code), a software module and data from the storage 1003 and/or the communication device 1004 into the memory 1002, and executes various types of processes in accordance therewith. An example of the program which is used is a program causing a computer to execute at least some of the operations described in the foregoing embodiment. For example, each of the functional units 11 to 18 of the three-dimensional space estimation device 10 is stored in the memory 1002, and may be realized by a control program which is operated by the processor 1001. Although the execution of various types of processes by one processor 1001 has been described above, these processes may be simultaneously or sequentially executed by two or more processors 1001. The processor 1001 may be implemented by one or more chips. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like. The memory 1002 can store a program (program code), a software module, or the like that can be executed in order to carry out a three-dimensional space estimation method according to an embodiment of the present invention.

The storage 1003 is a computer readable recording medium, and may be constituted by at least one of, for example, an optical disc such as a compact disc ROM (CD-ROM), a hard disk drive, a flexible disk, a magneto-optic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The foregoing storage medium may be, for example, a database including the memory 1002 and/or the storage 1003, a server, or another suitable medium.

The communication device 1004 is hardware (a transmitting and receiving device) for performing communication between computers through a wired and/or wireless network, and is also referred to as, for example, a network device, a network controller, a network card, a communication module, or the like.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel).

In addition, respective devices such as the processor 1001 and the memory 1002 are connected to each other through the bus 1007 for communicating information. The bus 1007 may be constituted by a single bus, or may be constituted by different buses between devices.

In addition, the three-dimensional space estimation device 10 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, at least one of these types of hardware may be mounted in the processor 1001.

Notification of information is not limited to the aspects/embodiments described in the present disclosure, and may be performed using other methods. For example, the notification of information may be performed by physical layer signaling (such as downlink control information (DCI) or uplink control information (UCI)), upper layer signaling (such as radio resource control (RRC) signaling, medium access control (MAC) signaling, or broadcast information (such as a master information block (MIB) and a system information block (SIB)), other signals, or combinations thereof. In addition, the RRC signaling may be referred to as an RRC message and may be referred to as, for example, an RRC connection setup message or an RRC connection reconfiguration message.

The aspects/embodiments described in the present disclosure may be applied to at least one of a system employing long term evolution (LTE), LTE-Advanced (LTE-A), SUPER 3G, IMT-Advanced, a 4th generation mobile communication system (4G), a 5th generation mobile communication system (5G), future radio access (FRA), new Radio (NR), W-CDMA (registered trademark), GSM (registered trademark), CDMA2000, ultra mobile broadband (UIMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended on the basis thereof. In addition, a plurality of systems may be combined (for example, 5G and at least one of LTE and LTE-A are combined or the like) and be applied.

The order of the processing sequences, the sequences, the flowcharts, and the like of the aspects/embodiments described above in the present disclosure may be changed as long as they are compatible with each other. For example, in the methods described in the present disclosure, various steps as elements are presented using an exemplary order but the methods are not limited to the presented specific order.

A specific operation which is performed by a base station in this specification may be performed by an upper node with respect thereto in some cases. In a network constituted by one or a plurality of network nodes including the base station, it is obvious that various operations which are performed to communicate with a terminal can be performed by at least one of the base station and network nodes other than the base station (for example, an MIME or an S-GW can be conceived but the network nodes are not limited thereto). A case in which the number of network nodes other than the base station is one has been described above, but a combination of a plurality of different network nodes (for example, an MIME and an S-GW) may be used.

Information or the like can be output from an upper layer (or a lower layer) to a lower layer (or an upper layer). Information or the like may be input or output via a plurality of network nodes.

The input or output information or the like may be stored in a specific location (for example, a memory) or may be managed in a management table. The input or output information or the like may be overwritten, updated, or added. The output information or the like may be deleted. The input information or the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects/embodiments described in the present disclosure may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Hereinbefore, the present disclosure has been described in detail, but it is apparent to those skilled in the art that the present disclosure should not be limited to the embodiments described in the present disclosure. The present disclosure can be implemented as modified and changed aspects without departing from the spirit and scope of the present disclosure, which are determined by the description of the scope of claims. Therefore, the description of the present disclosure is intended for illustrative explanation only, and does not impose any limited interpretation on the present disclosure.

Regardless of whether it is called software, firmware, middleware, microcode, hardware description language, or another name, software can be widely construed to refer to commands, a command set, codes, code segments, program codes, a program, a sub-program, a software module, an application, a software application, a software package, a routine, a sub-routine, an object, an executable file, an execution thread, an order, a function, or the like.

In addition, Software, a command, and the like may be transmitted and received via a transmission medium. For example, when software is transmitted from a web site, a server, or another remote source using wired technology such as a coaxial cable, an optical fiber cable, a twisted-pair wire, or a digital subscriber line (DSL) and/or wireless technology such as infrared rays, radio waves, or microwaves, the wired technology and/or the wireless technology are included in the definition of a transmission medium.

Information, a signal or the like described in the present disclosure may be expressed using any of various different techniques. For example, data, an instruction, a command, information, a signal, a bit, a symbol, and a chip which can be mentioned in the overall description may be expressed by a voltage, a current, an electromagnetic wave, a magnetic field or magnetic particles, an optical field or photons, or any combination thereof.

Meanwhile, the terms described in this specification and/or the terms required for understanding the present disclosure may be substituted by terms having the same or similar meanings.

The terms “system” and “network” which are used in the present disclosure are used interchangeably.

In addition, information, parameters, and the like described in the present disclosure may be expressed as absolute values, may be expressed by values relative to a predetermined value, or may be expressed by other corresponding information. For example, radio resources may be indicated by indices.

The names used for the above-described parameters are not limited in any way. Further, mathematical formulas and the like using these parameters may differ from those explicitly disclosed in the present disclosure. Various channels (for example, a PUCCH, a PDCCH, and the like) and information elements can be identified using all the preferred names, and various names assigned to such various channels and information elements are not limited in any aspect.

The term “determining” which is used in the present disclosure may include various types of operations. The term “determining” may include regarding operations such as, for example, judging, calculating, computing, processing, deriving, investigating, looking up/search/inquiry (for example, looking up in a table, a database or a separate data structure), or ascertaining as an operation such as “determining.” In addition, the term “determining” may include regarding operations such as receiving (for example, receiving information), transmitting (for example, transmitting information), input, output, or accessing (for example, accessing data in a memory) as an operation such as “determining.” In addition, the term “determining” may include regarding operations such as resolving, selecting, choosing, establishing, or comparing as an operation such as “determining.” That is, the term “determining” may include regarding some kind of operation as an operation such as “determining.” In addition, the term “determining” may be replaced with the term “assuming,” “expecting,” “considering,” or the like.

An expression “on the basis of” which is used in the present disclosure does not refer to only “on the basis of only,” unless otherwise described. In other words, the expression “on the basis of” refers to both “on the basis of only” and “on the basis of at least.”

Any reference to elements having names such as “first” and “second” which are used in the present disclosure does not generally limit amounts or an order of the elements. The terms can be conveniently used to distinguish two or more elements in this specification. Accordingly, reference to first and second elements does not mean that only two elements are employed or that the first element has to precede the second element in any form.

The term “means” in the configuration of each device may be substituted by the term “unit,” “circuit,” “device,” or the like.

Insofar as the terms “include” and “including” and modifications thereof are used in this specification or the claims, these terms are intended to have a comprehensive meaning similarly to the term “comprising.” Further, the term “or” which is used in this specification or the claims is intended not to mean an exclusive logical sum.

In the present disclosure, when articles are added by translation like, for example, “a,” “an,” and “the” in English, the present disclosure may include that nouns that follow these articles are plural forms.

In the present disclosure, an expression “A and B are different” may mean that “A and B are different from each other.” Meanwhile, the expression may mean that “A and B are different from C.” The terms “separated,” “coupled,” and the like may also be construed similarly to “different.”

The three-dimensional space estimation system 1 of the present disclosure may have the following configurations.

[1]

A three-dimensional space estimation system configured to estimate a three-dimensional space represented in a two-dimensional image, the system comprising:
a relative depth acquisition unit configured to acquire relative depth information indicating a relative depth of each pixel of the two-dimensional image which is an image obtained by projecting the three-dimensional space;
a reference line setting unit configured to detect one or more straight lines from the two-dimensional image and set the detected straight lines as reference lines;
a reference point setting unit configured to set a plurality of points per reference line as reference points on the reference line and set three-dimensional coordinates of each reference point in the three-dimensional space by using a first coefficient for converting the relative depth into an absolute depth in common for at least each reference point;
a two-dimensional coordinate acquisition unit configured to acquire two-dimensional coordinates of each reference point in the two-dimensional image;
a parameter calculation unit configured to calculate parameters of the conversion formula and the first coefficient by substituting the three-dimensional coordinates and the two-dimensional coordinates of the reference point into a predetermined conversion formula that expresses a relationship between three-dimensional coordinates in the three-dimensional space and two-dimensional coordinates in the two-dimensional image using predetermined parameters; and
a three-dimensional space model generation unit configured to generate a three-dimensional space model representing the three-dimensional space by arranging pixel values of each pixel of the two-dimensional image at corresponding positions in the three-dimensional space using at least a portion of the parameters calculated by the parameter calculation unit, the first coefficient, and the relative depth of each pixel.
   [2]

The three-dimensional space estimation system according to [1], wherein the reference point setting unit sets the plurality of reference points at equal intervals.

[3]

The three-dimensional space estimation system according to [1] or [2], wherein the reference point setting unit
sets a first coordinate axis out of first to third coordinate axes in the three-dimensional space so as to be along the reference line, and
sets the three-dimensional coordinates in the three-dimensional space of each reference point by using the first coefficient and a second coefficient for converting the absolute depth into a distance along the first coordinate axis in common for each reference point.
   [4]

The three-dimensional space estimation system according to [3], wherein the parameters of the conversion formula include predetermined six camera external parameters, four camera internal parameters, and five parameters related to lens distortion of the camera, which are related to projection of the three-dimensional space onto the two-dimensional image, and
the reference point setting unit sets at least four reference points for one reference line.
   [5]

The three-dimensional space estimation system according to [4], wherein the parameter calculation unit calculates camera external parameters R and t, each having three degrees of freedom, camera internal parameters fₓ, f_{y}, cₓ, and c_{y}, and camera lens distortion-related parameters k₁, k₂, k₃, p₁, and p₂, as well as the first coefficient and the second coefficient, in the following conversion formula representing a relationship between three-dimensional coordinates (X, Y, Z) in a three-dimensional space and two-dimensional coordinates (u, v) in a two-dimensional image.

$$[ \begin{matrix}x \\ y \\ z\end{matrix} ] = R [ \begin{matrix}X \\ Y \\ Z\end{matrix} ] + t \qquad [ Expression 3 ]$$

$${x}^{′} = x / z$$

$${y}^{′} = y / z$$

$${x}^{″} = {x}^{′} ( 1 + {k}_{1} {r}^{2} + {k}_{2} {r}^{4} + {k}_{3} {r}^{6} ) + 2 {p}_{1} {x}^{′} {y}^{′} + {p}_{2} ( {r}^{2} + 2 {x}^{′2} )$$

$${y}^{″} = {y}^{′} ( 1 + {k}_{1} {r}^{2} + {k}_{2} {r}^{4} + {k}_{3} {r}^{6} ) + {p}_{1} ( {r}^{2} + 2 {y}^{′2} ) + 2 {p}_{2} {x}^{′} {y}^{′}$$

$$where {r}^{2} = {x}^{′2} + {y}^{′2}$$

$$u = {f}_{x} * {x}^{″} + {c}_{x}$$

$$v = {f}_{y} * {y}^{″} + {c}_{y}$$

[6]

The three-dimensional space estimation system according to any one of [1] to [5], wherein the reference line setting unit sets, as the reference line, one or more straight lines having the highest ranks in length among the one or more detected straight lines.

[7]

The three-dimensional space estimation system according to any one of [1] to [6], wherein the reference line setting unit sets a plurality of straight lines out of the one or more detected straight lines as the reference lines.

### REFERENCE SIGNS LIST

1 Three-dimensional space estimation system
10 Three-dimensional space estimation device
11 Image acquisition unit
12 Relative depth acquisition unit
13 Reference line setting unit
14 Reference point setting unit
15 Two-dimensional coordinate acquisition unit
16 Parameter calculation unit
17 Output unit
18 Three-dimensional space model generation unit
21 Two-dimensional image storage unit
22 Conversion formula storage unit
23 Three-dimensional space model storage unit
M1 Recording medium
m10 Main module
m11 Image acquisition module
m12 Relative depth acquisition module
m13 Reference line setting module
m14 Reference point setting module
m15 Two-dimensional coordinate acquisition module
m16 Parameter calculation module
m17 Output module
m18 Three-dimensional space model generation module
P1 Three-dimensional space estimation program
md Three-dimensional space model
rl Reference line
rp Reference point

1. A three-dimensional space estimation system configured to estimate a three-dimensional space represented in a two-dimensional image, the system comprising:
a relative depth acquisition unit configured to acquire relative depth information indicating a relative depth of each pixel of the two-dimensional image which is an image obtained by projecting the three-dimensional space;
a reference line setting unit configured to detect one or more straight lines from the two-dimensional image and set the detected straight lines as reference lines;
a reference point setting unit configured to set a plurality of points per reference line as reference points on the reference line and set three-dimensional coordinates of each reference point in the three-dimensional space by using a first coefficient for converting the relative depth into an absolute depth in common for at least each reference point;
a two-dimensional coordinate acquisition unit configured to acquire two-dimensional coordinates of each reference point in the two-dimensional image;
a parameter calculation unit configured to calculate parameters of a predetermined conversion formula and the first coefficient by substituting the three-dimensional coordinates and the two-dimensional coordinates of the reference point into the predetermined conversion formula that expresses a relationship between three-dimensional coordinates in the three-dimensional space and two-dimensional coordinates in the two-dimensional image using predetermined parameters; and
a three-dimensional space model generation unit configured to generate a three-dimensional space model representing the three-dimensional space by arranging pixel values of each pixel of the two-dimensional image at corresponding positions in the three-dimensional space using at least a portion of the parameters calculated by the parameter calculation unit, the first coefficient, and the relative depth of each pixel.

2. The three-dimensional space estimation system according to claim 1, wherein the reference point setting unit sets the plurality of reference points at equal intervals.

3. The three-dimensional space estimation system according to claim 1, wherein the reference point setting unit sets a first coordinate axis out of first to third coordinate axes in the three-dimensional space so as to be along the reference line, and sets the three-dimensional coordinates in the three-dimensional space of each reference point by using the first coefficient and a second coefficient for converting the absolute depth into a distance along the first coordinate axis in common for each reference point.

4. The three-dimensional space estimation system according to claim 3, wherein the parameters of the conversion formula include predetermined six camera external parameters, four camera internal parameters, and five parameters related to lens distortion of the camera, which are related to projection of the three-dimensional space onto the two-dimensional image, and
the reference point setting unit sets at least four reference points for one reference line.

5. The three-dimensional space estimation system according to claim 4, wherein the parameter calculation unit calculates camera external parameters R and t, each having three degrees of freedom, camera internal parameters fₓ, f_{y}, cₓ, and c_{y}, and camera lens distortion-related parameters k₁, k₂, k₃, p₁, and p₂, as well as the first coefficient and the second coefficient, in the following conversion formula representing a relationship between three-dimensional coordinates (X, Y, Z) in a three-dimensional space and two-dimensional coordinates (u, v) in a two-dimensional image.
$$[ \begin{matrix}x \\ y \\ z\end{matrix} ] = R [ \begin{matrix}X \\ Y \\ Z\end{matrix} ] + t \qquad [ Expression 1 ]$$
$${x}^{′} = x / z$$
$${y}^{′} = y / z$$
$${x}^{″} = {x}^{′} ( 1 + {k}_{1} {r}^{2} + {k}_{2} {r}^{4} + {k}_{3} {r}^{6} ) + 2 {p}_{1} {x}^{′} {y}^{′} + {p}_{2} ( {r}^{2} + 2 {x}^{′2} )$$
$${y}^{″} = {y}^{′} ( 1 + {k}_{1} {r}^{2} + {k}_{2} {r}^{4} + {k}_{3} {r}^{6} ) + {p}_{1} ( {r}^{2} + 2 {y}^{′2} ) + 2 {p}_{2} {x}^{′} {y}^{′}$$
$$where {r}^{2} = {x}^{′2} + {y}^{′2}$$
$$u = {f}_{x} * {x}^{″} + {c}_{x}$$
$$v = {f}_{y} * {y}^{″} + {c}_{y}$$

6. The three-dimensional space estimation system according to claim 1, wherein the reference line setting unit sets, as the reference line, one or more straight lines having the highest ranks in length among the one or more detected straight lines.

7. The three-dimensional space estimation system according to claim 1, wherein the reference line setting unit sets a plurality of straight lines out of the one or more detected straight lines as the reference lines.
